(19) United States
(12) Patent Application Publication
(10) Pub. No.: US 2023/0101220 A1
(43) Pub. Date: Mar. 30, 2023

(54) USB SECURE DATA STORAGE DEVICE, SYSTEM TO AUTHENTICATE THE SAME AND AUTHENTICATING METHOD OF THE SAME

(71) Applicant: REAL IDENTITY CO., LTD., Seoul (KR)

(72) Inventors: SEONG SU PARK, Yongin-si (KR); SUNG HOON JUNG, Paju-si (KR); SSUM GYU LEE, Seoul (KR)

(73) Assignee: REAL IDENTITY CO., LTD., Seoul (KR)

(21) Appl. No.: 17/486,391

(22) Filed: Sep. 27, 2021

(51) Int. Cl. G06F 21/32

(52) U.S. Cl. CPC G06F 21/32

(57) ABSTRACT

The present invention relates to a USB secure data storage device, a system for authenticating the same, and an authentication method. In the present invention, an external memory identifier is extracted from an external memory, a second authentication key corresponding to the external memory identifier is extracted from the mapping information using the extracted external memory identifier, and encrypted using the second authentication key. A USB security data storage device having a USB security data storage device and authenticating it, comprising a controller for writing data to the external memory or decrypting it using the second authentication key to read the data recorded in the external memory A system and an authentication method are disclosed. According to the USB security data storage device and the system and authentication method for authenticating it according to the present invention, since a user is authenticated using a biometric fingerprint, a security-enhanced USB security data storage device can be used. Multiple external memories can be installed and used.

### TECHNICAL FIELD

The present invention relates to a USB secure data storage device, SYSTEM TO AUTHENTICATE THE SAME AND AUTHENTICATING METHOD OF THE SAME, and more particularly, to a USB secure data storage device having a socket into which an external memory card can be inserted, and a system and authentication method for authenticating the same.

### BACKGROUND ART

With the development of data storage technology, various types of portable storage devices are being used. Among these portable storage devices, a flash memory equipped with a USB (Universal Serial Bus) interface has a large storage capacity, is portable, and is easy to connect to a PC. is being used However, such a USB flash memory has a relatively weak security function. In order to solve this security problem, there is also a USB flash memory having a function such as requiring a password to access a specific area of the USB flash memory. However, since it is possible to access data stored in the USB flash memory through means such as physical hacking by a hacker, or memory dump or copy, it is not a fundamental problem solving means.

A flash memory having a USB interface is usually referred to as a USB memory, a USB stick, and a USB stick memory, but in the present invention, it will be referred to as a USB stick. As the capacity of the flash memory used in the USB stick increases, users can use a large amount of data even with a single USB stick. Nevertheless, as IT technology develops, a large amount of data is pouring in, and the amount of data that needs to be stored is also increasing. For example, just a few years ago, a single movie took up about 1.4 Gbytes of capacity, but now the resolution has increased, so a single movie can reach 4.5 Gbytes. FIG. 1 is a block diagram of a conventional USB stick. The USB stick 100 is configured to include a connector 110, a USB interface unit 140, a control unit 150, and a flash memory 160. The connector 110 provides an interface for connecting a physical signal line for exchanging data with a host. The USB interface unit 140 provides an interface for transmitting data to and receiving data from a host by connecting to a USB bus according to the USB standard. The controller 150 converts the file system provided to the user to correspond to the physical address and command of the flash memory 160 so that the flash memory 160 can store data. When data stored in the flash memory 160 is accessed, the physical address of the flash memory is converted into a logical file system and provided in a form recognizable by the host. The flash memory 160 is a non-volatile memory, and stored data is not deleted even when power is not supplied.

On the other hand, in sites that require a high level of security, a USB stick with a security function is used. As described above, in order to improve the security function, a USB stick for authentication with a password is commercialized, and further, a USB stick with a fingerprint authentication function is used. However, a USB stick with such a security function is more expensive than a normal USB stick. In particular, USB sticks with added security functions are often used in offices that require a high level of security.

### DISCLOSURE

### Technical Problem

The present invention relates to a USB security data storage device capable of using a plurality of external memories using a USB stick to which a single security function, which is permitted for each user, is added, and a system and authentication method for authenticating the same.

### Technical Solution

The above object of the present invention is attainable by USB security data storage device having a memory socket; an external memory that can be detachably mounted on the memory socket; a fingerprint identifier for distinguishing an authenticated user's fingerprint from other users' fingerprints; a memory for storing mapping information for a fingerprint identifier and a second authentication key assigned to each available external memory identifier for distinguishing the authenticated user's fingerprint from other users' fingerprints;

and a control unit extracting an external memory identifier from the external memory, extracting a second authentication key corresponding to the external memory identifier from the mapping information using the extracted external memory identifier, encrypting the external memory identifier using the second authentication key and reading data recorded in the external memory by writing data to the memory or decrypting it using the second authentication key.

Wherein the external memory identifier is an identifier to distinguish a specific external memory from other external memories.

Another object of the present invention can be achieved by a method of authenticating an external memory in a USB security data storage device constituting an authentication system including a USB security data storage device having a memory slot in which an external memory can be detachably mounted and having a biometric fingerprint authentication function, and an authentication server for authenticating the biometric fingerprint. The method comprising a first step of obtaining a fingerprint identifier by receiving a fingerprint from a user and storing it; —The fingerprint identifier is used as an identifier to distinguish the user from other users—a second step of extracting the USB identifier and the external memory identifier and transmitting it to the authentication server; —The external memory identifier is an identifier for distinguishing a specific external memory from other external memories, and the USB identifier is an identifier used to distinguish a specific USB security data storage device from other USB security data storage devices—a third step of receiving a first authentication key generated using the USB identifier and the external memory identifier from the authentication server; a fourth step of generating a second authentication key using the first authentication key and the fingerprint identifier, and storing mapping information of the second authentication key mapped to the external memory identifier; and a fifth step of encrypting and storing data in the external memory using the second authentication key, or decrypting and reading the data is configured.

### Advantageous Effects

According to the USB security data storage device and the system and authentication method for authenticating it according to the present invention, since a user is authenticated using a biometric fingerprint, a security-enhanced USB security data storage device can be used. Multiple external memories can be installed and used.

In addition, the USB security data storage device according to the present invention stores and stores the second authentication key authenticated for each external memory, and accesses the external memory using the stored and read/write data through encryption and decryption. Therefore, a higher security level can be applied.

Furthermore, the USB security data storage device and the system and authentication method for authenticating it according to the present invention provide a system for managing an external memory matched with the authenticated USB security data device, so that it can be easily made it possible to manage.

Since the authentication key is not stored in the USB security data storage device and the system and authentication method for authenticating it according to the present invention, there is an advantage that there is no problem in the security of the biometric USB even if the security of the authentication server is breached by hacking.

### DESCRIPTION OF DRAWINGS

FIG. 1 is a block diagram of a conventional USB stick.

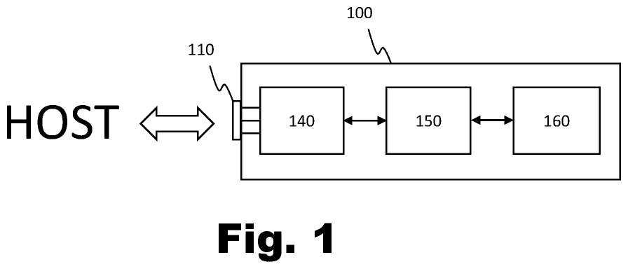

FIG. 2 is a perspective view of a USB stick of one embodiment in accordance with the present invention having a memory insertion socket;

FIG. 3 is a block diagram of a USB stick according to an embodiment of the present invention having a memory insertion socket;

FIG. 4 is a configuration diagram of a biometric fingerprint sensing unit and a biometric fingerprint authentication unit.

FIG. 5 is an overall configuration diagram of a system for authenticating a USB secure data storage device according to the present invention.

FIG. 6 is a flowchart showing a procedure for initially registering a USB security data storage device to be used by a user.

FIG. 7 is a flowchart illustrating a procedure for issuing an authentication key when using a registered biometric USB and SD card for the first time.

### MODE FOR INVENTION

The above-mentioned objectives, features, and advantages will be described in detail with reference to the accompanying drawings, and accordingly, those of ordinary skill in the art to which the present disclosure pertains should be able to easily practice the technical idea of the present disclosure. In describing the present disclosure, when detailed description of known art related to the present disclosure is deemed as having a possibility of unnecessarily obscuring the gist of the present disclosure, the detailed description will be omitted. Hereinafter, exemplary embodiments according to the present disclosure will be described in detail with reference to the accompanying drawings. Like reference numerals in the drawings refer to like or similar elements throughout.

Terms such as first and second are used to describe various elements, but the elements are of course not limited by the terms. The terms are merely used for distinguishing one element from another element, and a first element may also be a second element unless particularly described otherwise.

Hereinafter, when it is said that an arbitrary element is disposed at “an upper portion (or a lower portion)” of an element or disposed “above (or below)” an element, this may not only mean that the arbitrary element is disposed in contact with an upper surface (or a lower surface) of the element, but also mean that another element may be interposed between the element and the arbitrary element disposed above (or below) the element.

Also, when it is said that a certain element is “connected” or “coupled” to another element, this may mean that the elements are directly connected or coupled to each other, but it should be understood that another element may be “interposed” between the elements or the elements may be “connected” or “coupled” to each other via another element.

Through the specification, each element may be singular or plural unless particularly described otherwise.

A singular expression used herein encompasses a plural expression unless the context clearly indicates otherwise. In the present application, terms such as “consisting of” or “including” should not be interpreted as necessarily including all of various elements or various steps described herein and should be interpreted as indicating that some of the elements or some of the steps may not be included or additional elements or steps may be further included.

Throughout the specification, “A and/or B” may refer to A, B, or A and B unless particularly described otherwise, and “C to D” refers to C or more and D or less unless particularly described otherwise.

Hereinafter, a preferred embodiment of the present invention will be explained in detail with reference to the drawings.

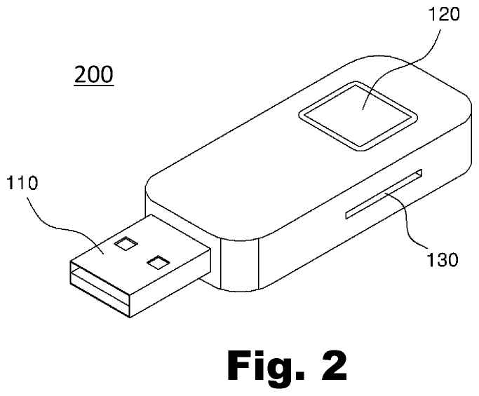

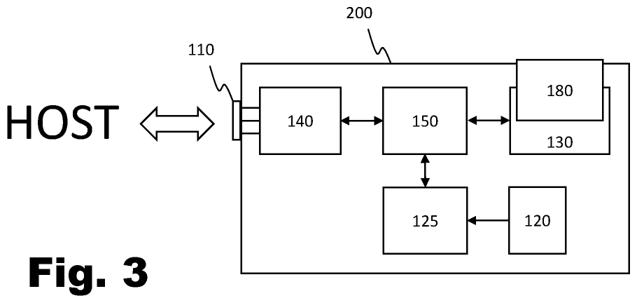

FIG. 2 is an external perspective view of a USB secure data storage device according to an embodiment according to the present invention, and FIG. 3 is an internal configuration diagram of the USB secure data storage device according to an embodiment according to the present invention.

A USB security data storage device according to an embodiment of the present invention will be described with reference to FIGS. 2 and 3. The USB security data storage device 200 according to the present invention includes a connector 110, a biometric fingerprint sensing unit 120, a biometric fingerprint authentication unit 125, a memory socket 130, a USB interface 140, and a first external memory. 180 and a control unit 150.

The connector 110 provides an interface for connecting a physical signal line for exchanging data with a host. The USB interface unit 140 provides an interface for transmitting data to and receiving data from a host by connecting to a USB bus according to the USB standard. The biometric fingerprint sensing unit 120 is a sensor unit for detecting a finger fingerprint of a living body, and the biometric fingerprint authentication unit 125 uses a signal input from the biometric fingerprint sensing unit 120 to determine whether it is a living body or not, and if it is a living body, it is registered. It is a module that authenticates whether or not it is a valid fingerprint. The memory socket 30 is a physical socket for inserting and installing a plurality of external memories 180, and is a physical interface electrically connecting the external memory 180 and the controller 150. The controller 150 converts the file system provided to the user to correspond to the physical address and command of the external memory 180 so that the external memory 180 can store data. When data stored in the external memory 180 is accessed, the physical address of the external memory is converted into a logical file system and provided in a form that the host can recognize. The external memory 180 is a non-volatile memory that is inserted and installed in the memory socket 130 in a removable manner, and is a storage device in which stored data is not deleted even if power is not supplied.

A module for detecting a living body and a biometric sensing method are described in U.S. Pat. No. 10,621,323, which was filed and registered by the inventor of the present application. It goes without saying that a living body can be detected by applying various known methods in addition to the technology disclosed in the corresponding patent. Since various techniques are known for an apparatus and method for detecting a fingerprint, a description thereof will be omitted.

The biometric fingerprint sensing unit 120 is a sensor unit for detecting a human finger fingerprint, and unlike the conventional fingerprint sensor unit, it can be understood as a sensor unit having a function of detecting whether a living body is added in addition to a function of detecting a fingerprint. For example, in order to apply the technology disclosed in U.S. Pat. No. 10,621,323, in addition to an electrode for sensing a fingerprint, two separate electrodes for detecting a living body must be provided.

The biometric fingerprint authentication unit 125 uses a signal input from the biometric fingerprint sensing unit 120 to calculate whether or not a biometric is a biometric and, when it is determined as a biometric, a feature point (fingerprint data, fingerprint key) of the fingerprint, and pre-registered fingerprint data It is a module that compares with (fingerprint key) to determine whether it matches or not. The order in which the biometric fingerprint authentication unit 125 performs biometric authentication and fingerprint authentication does not matter much, and both may be performed simultaneously.

As will be described later, the USB security data storage device is provided with authenticated user fingerprint data (fingerprint key) and a second authentication key generated for each external memory. The fingerprint key and the second authentication key for each external memory are stored in a small-capacity memory provided in the control unit 150 or the biometric fingerprint authentication unit 125, or a separate small-capacity internal memory is provided and stored in the corresponding internal memory.

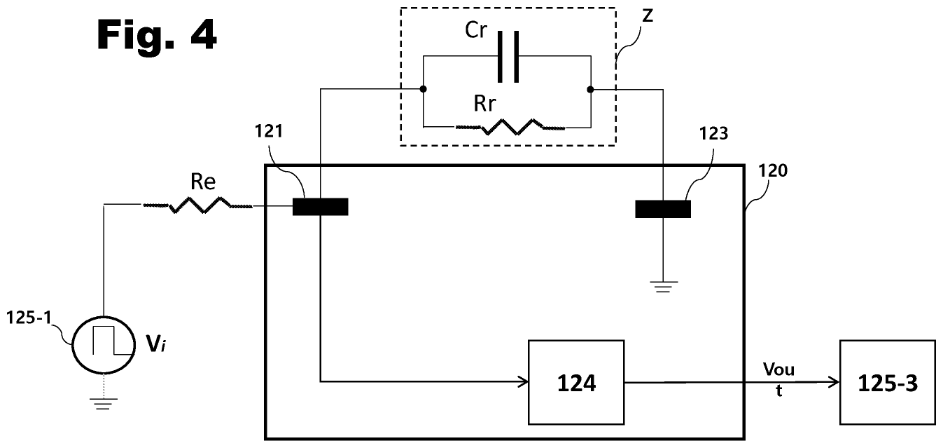

FIG. 4 is a configuration diagram of a biometric fingerprint sensing unit and a biometric fingerprint authentication unit. In FIG. 4, reference symbol ‘Z’ is an equivalent circuit of a biometric fingerprint. The configuration shown in FIG. 4 shows only the biometric sensing unit and the biometric authentication unit for detecting and authenticating only the presence of a biological body. The biometric fingerprint sensing unit and the biometric fingerprint authentication unit will be completed only when the fingerprint sensing unit and the fingerprint authentication unit are added to the configuration shown in FIG. Strictly, the configuration shown in FIG. 4 should be called a biometric sensor and a biometric authentication unit. However, if the fingerprint sensing unit and the fingerprint authentication unit are added, respectively, the biometric fingerprint sensing unit and the biometric fingerprint authentication unit can be configured for convenience. Let's call it the fingerprint authentication unit.

In the equivalent circuit of the device related to biometric authentication, the second biometric electrode 123 is connected to the ground, and one end of the biometric first electrode 121 is connected to the ground through the resistor Re and the driving unit 125-1. connected, and the biosensing first electrode 121 is also connected to the sensing unit 124. The sensing unit 124 is composed of an amplifier and a D/A converter, and outputs a voltage value sensed by the biosensing first electrode 121 as a digital value.

An operation principle for performing biometric authentication will be briefly described with reference to FIG. 4. In a state where the biosensing first electrode 121 and the biosensing second electrode 123 are positioned close to the living body Z, the driving unit 125-1 transmits a square wave having a single cycle to the biosensing first electrode 121. In a state in which the voltage measured by the biosensing first electrode 121 is stabilized, the voltage value sensed by the biosensing first electrode 121 is output to the control and signal processing unit 125-3.

The control and signal processing unit 125-3 is configured to include a signal processing unit and a control unit. The signal processing unit detects the highest measured voltage that is the highest value of the sensed voltage value and the lowest measured voltage that is the lowest value of the sensed voltage from the sensed voltage value. Then, the measured voltage width (Vw) obtained by the difference between the measured voltage maximum value and the measured voltage minimum value and the time (Tm) required for the detected voltage to reach a specific range from the measured voltage minimum value to the measured voltage maximum value are signal-processed. The control unit applies an operation control signal necessary for the driving unit 125-1, the sensing unit 124, and the signal processing unit. The control and signal processing unit 125-3 uses the measured voltage width (Vw) and the required time (Tm) detected by the signal processing unit to authenticate whether a living body is present.

In FIG. 4, the bio-fingerprint sensing unit 120 includes a bio-sensing first electrode 121, a bio-sensing second electrode 123, and a sensing unit 124, but a resistor Re and a driving unit Vi) Of course, it can also be implemented as a component included in the biometric fingerprint sensing unit 120. In addition, although the biometric fingerprint authentication unit is illustrated as being composed of only the driving unit 125-1 and the control and signal processing unit 125-3, it includes a small-sized memory and can be implemented to include various components for authenticating the biometric.

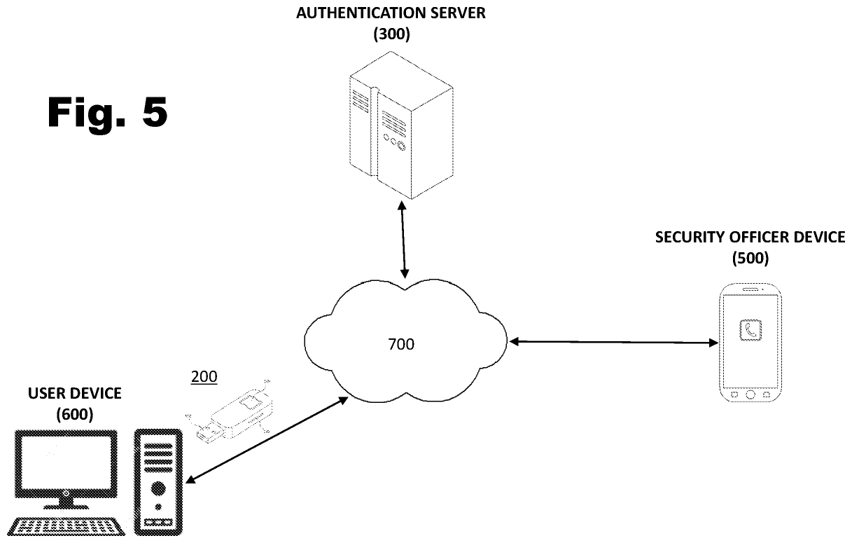

FIG. 5 is an overall configuration diagram of a system for authenticating a USB secure data storage device according to the present invention. The authentication system for authenticating the USB security data storage device is composed of a USB security data storage device 200, an authentication server 300, a security officer device 500, and a user device 600 connected to each other through the Internet network 700. The authentication server 300 stores external memory information permitted for use by each USB security data storage device, and generates a first authentication key using an identifier of the USB security data storage device and an external memory identifier to generate a USB security data storage device. It is responsible for the function provided to (200).

The security officer device 500 is a general computer device or mobile device having an input/output device managed by the security officer, and as will be described later, user (employee) information (employee number, resident registration number, etc.) who is permitted to use the USB security data storage device, information on the USB security data storage device used by the user and information on the external memory permitted for use in each USB security data storage device are stored. Here, the management means that the security officer device 500 can be used after being authenticated with a password or the like. The USB security data storage device 200 authenticates the user using the stored fingerprint identification information, and generates a second authentication key using the first authentication key received from the authentication server 300 and the fingerprint identification information stored therein, it is used to encrypt the data in the external memory and then store or decrypt it and read it. The fingerprint identification information is stored in a small-capacity memory provided in the control unit 150 or the biometric fingerprint authentication unit 125 of the USB security data storage device 200, or a separate small-capacity internal memory is provided and stored in the corresponding internal memory.

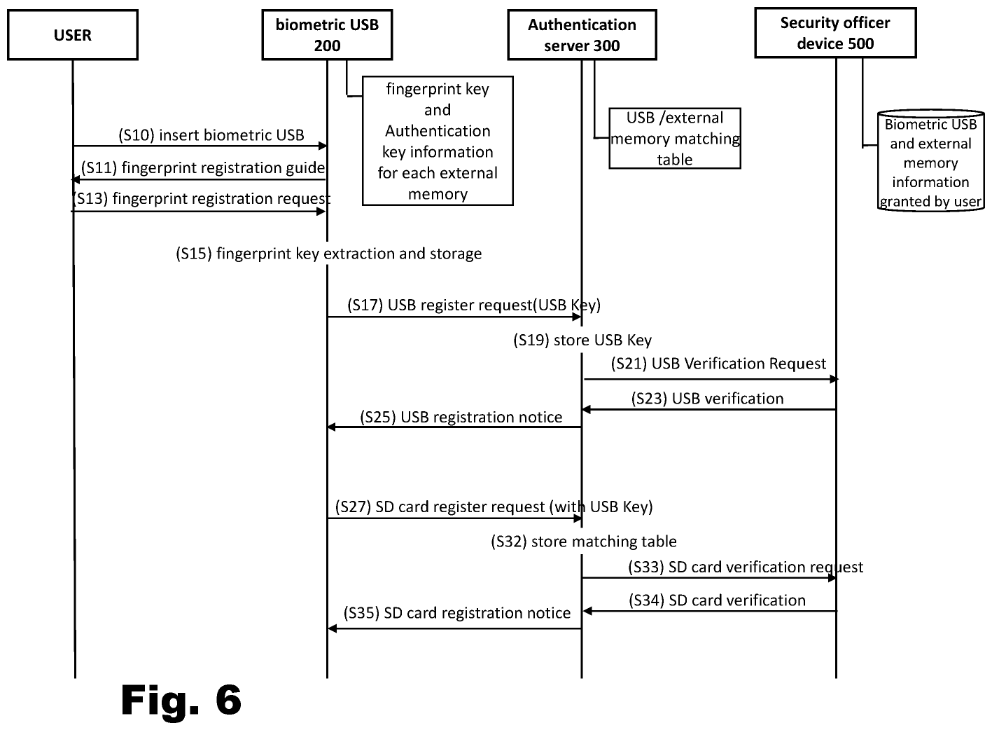

FIG. 6 is a flowchart showing a procedure for initially registering a USB secure data storage device to be used by a user. In the following description, ‘USB secure data storage device according to the present invention’ will be briefly abbreviated as ‘biological USB’. A series of procedures necessary for use registration according to FIG. 6 is sequentially performed by a user registration program provided in the user device, the security officer device 500 or the biometric USB 200. In FIG. 6, for convenience of explanation, it is assumed that the user registration program is provided in the user device, and the description will be made on the assumption that the bio-USB is inserted and installed in the user device.

The security officer grants each user the information on the entire bio-USB list, the entire external memory list, and to which users each bio-USB and each external memory is allowed, and stores them in the bio-USB and external memory tables do. Specifically, the security officer manages only the user's company number (or resident registration number), the biometric USB serial number (USB key) allowed for use by each user, and the serial number (SD key) of the external memory in the table, and the first authentication key and the second It is assumed that no authentication key used for encryption/decryption is stored, such as an authentication key.

As shown in FIG. 6, when the biometric USB 200 is inserted into the user device to use and register the biometric USB 200 (S10), the user is guided to register the fingerprint (S11), and the fingerprint registration is requested (S13). When the user provides a fingerprint, the biometric USB 200 extracts fingerprint identification data from the input fingerprint and stores it. Here, the fingerprint identification data is an identifier used to distinguish a specific user from other users. In the present invention, biometric authentication is performed and fingerprint data extracted from the user's fingerprint is used. Hereinafter, ‘fingerprint identification data’ will be referred to as ‘fingerprint key’. The fingerprint key may be stored in any one of the control unit of the biometric USB 200, the biometric fingerprint authentication unit, or the internal memory. Of course, extracting the fingerprint identification data from the received fingerprint may be performed in the user device instead of the biometric USB 200. Next, the biometric USB registration step is carried out. The biometric USB 200 requests USB registration while transmitting the USB identifier to the authentication server 300 (S17). The USB identifier is an identifier for distinguishing a specific biometric USB device from other biometric USB devices, and is an identifier uniquely assigned to a biometric USB device. Such a USB identifier may be, for example, a serial number of one piece of hardware (ex: control unit) constituting the bio-USB or a serial number of a program included in the bio-USB. Hereinafter, the ‘USB identifier’ will be referred to as a ‘USB Key’.

The authentication server 300 stores the USB key and requests the security officer device 500 to confirm whether it is possible to use the biometric USB for the USB key (S21). When such a request is received, the security officer device 500 checks whether the USB key is a valid biometric USB possessed by each user through the biometric USB and external memory table, and if it is a valid biometric USB, uses the biometric USB authentication server 300 (S32), and the authentication server 300 notifies the biometric USB 200 that the device registration has been completed (S25). The security officer device 500 does not authenticate the use of an invalid biometric USB. In the method in which the security officer device 500 authenticates the biometric USB, the authentication server 300 requests authentication by text to the security officer device 500, and the security officer checks the biometric USB and external memory table granted by each user and returns It may proceed with the process of notifying the use approval by text.

Next, perform the external memory registration procedure. After extracting the external memory identifier inserted into the memory socket, registration is requested to the authentication server 300 (S27). At this time, the USB key is also transmitted. The external memory identifier is an identifier for distinguishing a specific external memory from other external memories, and a serial number assigned to hardware by the manufacturer of the external memory at the time of shipment from the factory or a serial number for distinguishing a program can be used as an external memory identifier. Such a serial number may be a serial number of an MCU (Micro Controller Unit) constituting an external memory. For convenience of explanation, the external memory will be described assuming that an SD card is used, and the identifier of the SD card will be abbreviated as ‘SD key’. The authentication server 300 stores the SD keys usable for each USB key in the USB/external memory matching table (S32). The authentication server 500 transmits the SD key to the security officer device 500 and inquires whether it is a valid SD card (S33), and the security officer device 500 uses a biometric USB and external memory table that is valid for each user. Check whether it is an SD key and grant use (S34). When the authentication server 300 receives approval for use, the biometric USB and SD card registration is completed by storing it in the USB/external memory matching table and notifying the biometric USB of the SD card registration (S35).

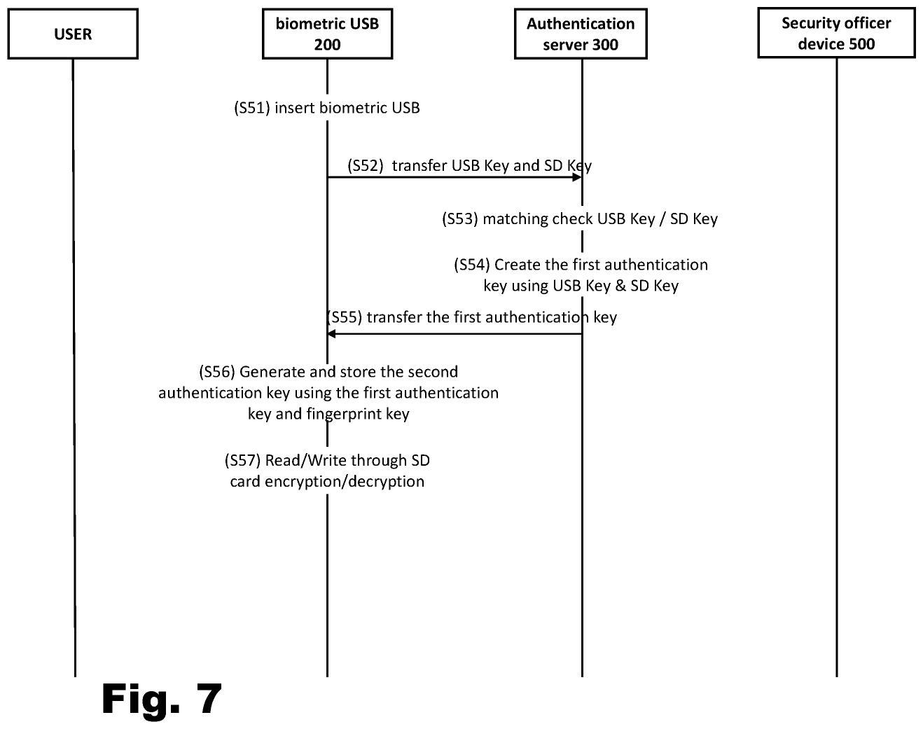

FIG. 7 is a flowchart illustrating a procedure for issuing an authentication key when using a registered biometric USB and SD card for the first time. The biometric USB into which the SD card is inserted is inserted into the user device (S51). The user device extracts the USB key and SD key and transmits it to the authentication server 300 (S52). The authentication server 300 uses the USB/external memory matching table to check whether the received SD key is an SD key usable in the corresponding USB key (S53). In the case of a usable SD key, the first authentication key is generated using the USB key and the SD key (S54), and then transmitted to the biometric USB 200 (S55). After receiving the first authentication key, the biometric USB 200 generates a second authentication key using the first authentication key and the fingerprint key stored therein, and stores it in the SD-specific authentication key table (S56).

In the present invention, the authentication server 300 generates the first authentication key using the USB key and the SD key, but does not store the generated first authentication key to minimize the risk of hacking. However, it is preferable to implement the authentication server 300 to keep the log records generated when the first authentication key is generated, and to refer to the log records in case of loss of the biometric USB to be used for reissuance. A plurality of SD cards can be inserted and used in the bio-USB 200. In the present invention, information on the second authentication key for the SD card permitted to be used in each biometric USB 200 is stored and managed in the form of an authentication key table for each SD. Of course, the SD-specific authentication key table can be managed not only in the form of a table, but also in the form of a file. In the present invention, although the SD-specific authentication key table is named, it should be interpreted as including all forms of storing information on the second authentication key generated for each SD. Table 1 shows an example of the authentication key table generated for each SD card when there are n SD cards permitted to be used in one biometric USB.

TABLE 1

| SD card classification | 2nd authentication key |
|---|---|
| 1^{st} SD Card | #1 Second authentication |
| | key |
| 2^{nd} SD Card | #2 Second authentication |
| | key |
| . . . | . . . |
| Nth SD Card | #n Second authentication |
| | key |

A method of using the biometric USB after the second authentication key is issued so that the SD card can be used in the biometric USB according to FIG. 7 will be briefly described. When the bio-USB with the SD card inserted into the user device is inserted, the controller of the bio-USB extracts the SD key, and then uses the extracted SD key to bring the second authentication key issued to the corresponding SD key from the SD-specific authentication key table. Data is read by encrypting and writing data to the SD card using the second authentication key or decrypting the data. Data encryption can encrypt the entire file system of the SD card, and can also encrypt the data sent and received during Read/Write access. A case in which an authenticated user attempts to use an unauthorized second external memory by inserting it into the memory socket of the biometric USB will be described. After extracting the identifier from the corresponding second external memory, the biometric USB verifies whether there is a second authentication key corresponding to the extracted second external memory identifier using the SD-specific authentication key table. Since the authentication key table for each SD will not have a matching second authentication key other than the non-authenticated second external memory, the second authentication key cannot be given, and data cannot be read or written. Therefore, even a user who is authenticated to use a biometric USB cannot use an unauthorized external memory. When the user no longer uses the biometric USB (for example, when the user leaves the company or loses it), the fingerprint key and SD-specific authentication key table stored in the biometric USB 200 are initialized, and the authentication server Initializes the USB/external memory matching table stored in (300). However, in case of loss, it is difficult to initialize the fingerprint key stored in the biometric USB 200 and the authentication key table for each SD. In addition, the security officer will update the USB key and external memory information for each user and keep it up to date for the next use.

In the above, preferred embodiments of the present invention have been described and illustrated using specific terms, but such terms are only for clearly describing the present invention, and the embodiments and described terms of the present invention are the spirit and scope of the following claims. It is obvious that various changes and changes can be made without departing from it. Such modified embodiments should not be separately understood from the spirit and scope of the present invention, but should be considered to fall within the scope of the claims of the present invention.

1. A USB security data storage device having
a memory socket;
an external memory that can be detachably mounted on the memory socket;
a fingerprint identifier for distinguishing an authenticated user's fingerprint from other users' fingerprints;
a memory for storing mapping information for a fingerprint identifier and a second authentication key assigned to each available external memory identifier for distinguishing the authenticated user's fingerprint from other users' fingerprints; and
a control unit extracting an external memory identifier from the external memory, extracting a second authentication key corresponding to the external memory identifier from the mapping information using the extracted external memory identifier, encrypting the external memory identifier using the second authentication key and reading data recorded in the external memory by writing data to the memory or decrypting it using the second authentication key and
wherein the external memory identifier is an identifier to distinguish a specific external memory from other external memories.

2. The USB security data storage device of claim 1 further comprising
a biometric fingerprint sensing unit, which is a sensor unit for detecting a finger fingerprint of a living body, and
a biometric fingerprint authentication unit for authenticating whether a biometric or not a registered fingerprint in case of a biometric using a signal input from the biometric fingerprint sensing unit.

3. The USB security data storage device of claim 2, wherein the control unit extracts an external memory identifier from the external memory only when authentication of the biometric fingerprint authentication unit is completed, and extracts a second authentication key corresponding to the external memory identifier from the mapping information using the extracted external memory identifier, writes data to the external memory by encrypting it using the second authentication key or reads the data recorded in the external memory by decrypting it using the second authentication key.

4. An authentication system that authenticates a USB security data storage device,
the USB security data storage device having a memory socket in which an external memory can be removably inserted and installed, and storing mapping information for a second authentication key authenticated by a user's fingerprint identifier and the external memory identifier therein; and
an authentication server receives a USB identifier and the external memory identifier from the USB security data storage device, storing information on the external memory authenticated to be usable for each USB identifier, generating a first authentication key using the USB identifier and the external memory identifier and providing the first authentication key to the USB security data storage device;
wherein the fingerprint identifier is an identifier for distinguishing the authenticated user's fingerprint from other users' fingerprints, and the external memory identifier is an identifier for distinguishing a specific external memory from other external memories and the USB identifier is an identifier for distinguishing a specific USB security data storage device from other USB security data storage devices, and the external memory identifier is an identifier for identifying a specific external memory from other external memories and the USB security data storage device generates a second authentication key using the first authentication key and the fingerprint identifier stored therein, and then stores it as the mapping information for the second authentication key authenticated for each external memory identifier.

5. The authentication system of claim 4, wherein the USB security data storage device extracts the identifier of the external memory, obtains the second authentication key from the mapping information, and stores encrypted data in the external memory using a second authentication key when the user wants to use the USB security data storage device while the external memory is installed in the memory socket.

6. A method of authenticating an external memory in a USB security data storage device constituting an authentication system including a USB security data storage device having a memory slot in which an external memory can be detachably mounted and having a biometric fingerprint authentication function, and an authentication server for authenticating the biometric fingerprint, the method comprising
a first step of obtaining a fingerprint identifier by receiving a fingerprint from a user and storing it;
a second step of extracting the USB identifier and the external memory identifier and transmitting it to the authentication server;
a third step of receiving a first authentication key generated using the USB identifier and the external memory identifier from the authentication server;
a fourth step of generating a second authentication key using the first authentication key and the fingerprint identifier, and storing mapping information of the second authentication key mapped to the external memory identifier; and
a fifth step of encrypting and storing data in the external memory using the second authentication key, or decrypting and reading the data is configured
wherein the fingerprint identifier is used as an identifier to distinguish the user from other users and the external memory identifier is an identifier for distinguishing a specific external memory from other external memories, and the USB identifier is an identifier used to distinguish a specific USB security data storage device from other USB security data storage devices.

7. The method of claim 6, wherein the authentication server uses the USB identifier and the external memory identifier to store matching information of the external memory identifier that can be used for each USB secure data storage device.
